(19) United States
(12) Patent Application Publication
(10) Pub. No.: US 2024/0017960 A1
(43) Pub. Date: Jan. 18, 2024

(54) METHOD AND CONTROLLER FOR EVALUATING INFORMATION ABOUT A CURRENT LOCATION OF A CAR IN A SHAFT OF AN ELEVATOR

(71) Applicant: Inventio AG, Hergiswil (CH)

(72) Inventor: Valerio Villa, Colverde (IT)

(21) Appl. No.: 18/256,643

(22) PCT Filed: Dec. 15, 2021
(86) PCT No.: PCT/EP2021/085958

§ 371 Date: Jun. 9, 2023

(30) Foreign Application Priority Data
Dec. 16, 2020 (EP) 20214659.3

(51) Int. Cl. B66B 1/34

(52) U.S. Cl. CPC B66B 1/3492

(57) ABSTRACT

A method and controller evaluate information about a current location of a car in a shaft of an elevator. The method includes the steps of: measuring a distance between a car reference position at the car and a shaft reference position in the shaft using a laser distance measuring device; acquiring laser quality data from the laser distance measuring device, the laser quality data representing a quality of a laser beam detected by the laser distance measuring device upon measuring the distance; and evaluating the information about the current location of the car taking into account the measured distance and the laser quality data.

### FIELD

The present invention relates to a method for evaluating information about a current location of a car in a shaft of an elevator. The invention also relates to a method for operating an elevator. Furthermore, the invention relates to a controller configured for implementing such method and to an elevator comprising such controller.

### BACKGROUND

In elevators, a car is generally displaced along a shaft for approaching various floors at different levels throughout a building. In order to implement safety measures and/or in order to implement functionalities such as precisely displacing the car throughout the shaft and stopping the travelling car precisely at an intended level, a current location of the car in the shaft has to be known. The information about the current location of the car may for example be used by an elevator controller controlling a drive engine, a braking mechanism and/or other functionalities within the elevator.

There are various conventional methods and techniques for determining information about the current location of the car in the shaft. Typically, such methods and techniques have to fulfil strict safety requirements in order to provide the location information with high reliability.

EP 2 516 304 B1 discloses a floor position detection device of an elevator system. Therein, Hall sensors are used for detecting magnetic markers positioned at different locations throughout the elevator shaft. While such approach for determining information about the location of the car based on locally detecting one or more of a multiplicity of distributed magnetic markers may provide for a precise and reliable position detection, it generally requires complex hardware. Accordingly, fabrication, installation and/or maintenance of the position detection device may be laborious and expensive.

GB 2211046 A discloses a device for monitoring the movement of a car in a shaft. Therein, a laser transmitter is positioned at one end of the shaft so as to transmit a laser beam along a length of the shaft. A reflector is mounted on the car so as to reflect the laser beam back to a receiver positioned adjacent to the transmitter. An output of the receiver is monitored to determine the position of the car in the shaft and the velocity of the car relative to the shaft.

However, it has been found that such laser-based monitoring of the current position of the car may be subject to various disturbing influences or errors such that a reliability of such approach may be insufficient for some safety-critical applications.

### SUMMARY

There may be a need for a method for evaluating information about a current location of a car in a shaft of an elevator, the method requiring relatively simple hardware and/or hardware being easy to install and/or to maintain, while providing for a sufficient reliability of determined position information. Additionally, there may be a need for a method for operating an elevator in which the car location is evaluated in the indicated manner. Furthermore, there may be a need for a controller for implementing such method and for an elevator comprising such controller.

Such needs may be met with the subject-matter of the advantageous embodiments defined in the following specification and in the figures.

According to a first aspect of the present invention, a method for evaluating information about a current location of a car in a shaft of an elevator is proposed. The method comprises at least the following steps, preferably in the indicated order: measuring a distance between a car reference position at the car and a shaft reference position in the shaft using a laser distance measuring device,

acquiring laser quality data from the laser distance measuring device, the laser quality data representing a quality of a laser beam detected by the laser distance measuring device upon measuring the distance, and
evaluating the information about the current location of the car taking into account the measured distance and the laser quality data.

According to a second aspect of the invention, a method for operating an elevator is proposed. Therein, functions of the elevator are controlled based on information about a current location of a car in a shaft of the elevator evaluated with a method according an embodiment of the first aspect of the invention.

According to a third aspect of the invention, a controller for determining information about a current location of a car in a shaft of an elevator is proposed. Therein, the controller is configured for implementing and/or controlling a method according to an embodiment of one of the first and second aspects of the invention.

According to a fourth aspect of the invention, an elevator is proposed, the elevator comprising, inter-alia, a car, a shaft, a laser distance measuring device for measuring a distance between a car reference position at the car and a shaft reference position at the shaft and further comprising a controller according to an embodiment of the third aspect of the invention.

Ideas underlying embodiments of the present invention may be interpreted as being based, inter alia, on the following observations and recognitions.

As already briefly indicated further above, techniques have been developed for detecting the current location of a car in an elevator shaft. In order to enable using the determined location information for safety critical applications, such techniques have to be reliable. For example, such techniques have to comply with an elevated safety integrity level such as e.g. an SIL2 or even SIL3. Accordingly, conventional car location determination techniques in elevators are generally complex and expensive.

Briefly summarized, the approach described herein seeks to use a simple and relatively cheap technique for evaluating or finally determining the current car location in the elevator shaft and to significantly increase a reliability of such technique. Specifically, a laser distance measuring device shall be applied for measuring a distance between a fixed reference position in the elevator shaft and another reference position at the car. As it has been found that a result of such distance measuring may be subject to various influences and disturbances possibly resulting in erroneous measurement results, it is suggested to additionally acquire laser quality data. Such laser quality data is representing a quality of a laser beam detected by the laser distance measuring device while it is measuring the indicated distance. While such laser quality data do not comprise information which would be sufficient to measure the indicated distance in a sufficiently unambiguous manner, such quality data may provide additional information about the distance measuring process. Such additional information may then be taken into account upon evaluating the information about the current location of the car based on the distance as measured by the laser distance measuring device in order to thereby increase a reliability of such measurement. Preferably, the laser quality data may be acquired using one or more data sources which are already accessible in the elevator arrangement. For example, a light sensor comprised in the laser distance measuring device for detecting reflected portions of an emitted laser beam may, as its main purpose, provide signals and data based on which the distance to a reflecting object may be determined and may, as an additional source of information, provide signals and data indicating the laser quality of the reflected portions of the laser beam. Finally, by evaluating the information about the current location of the elevator car based on both, the distance measured by the laser distance measuring device as well as the acquired laser quality data, the resulting overall car location information may be provided with a substantially higher reliability than it is the case when only measurements of the laser distance measuring device would be used without additionally taking into account the laser quality data. Accordingly, with the approach described herein, car location evaluation and determination may be implemented with relatively simple and cheap hardware and, as the determination results may be provided with an increased reliability, the provided car location information may be used even upon increased safety and reliability requirements. Particularly, the proposed approach generally requires few or no additional hardware for increasing the reliability of the measurement results of the laser distance measuring device, as hardware for providing suitable laser quality data is generally accessible in an elevator arrangement and/or its laser distance measuring device, anyway.

In the following, possible embodiments of the approach proposed herein shall be described in more detail.

The laser distance measuring device applied for measuring the distance between the car reference position and the shaft reference position may be a device which emits a laser beam towards an object and detects portions of the laser beam upon being reflected at the object in order to then measure a distance of the object based on analyzing the detected laser beam portions. For example, the laser distance measuring device may use a time-of-flight (TOF) technique for measuring the distance of the object. Therein, a measured duration between emitting laser light and receiving reflected portions of the laser light is used for calculating the distance of the reflecting object. Optionally, a phase shift in oscillations phases between the emitted laser light and the received laser light may be used for determining the time-of-flight.

The laser distance measuring device may comprise a laser source for emitting the laser beam, a light detector for detecting the reflected laser beam light and a processing unit for analyzing the signals provided by the light detector. The laser distance measuring device may be a conventional, commercially available device of relatively simple construction and/or high robustness. The laser source may emit any kind of laser beam such as a laser beam in the visible spectrum or an invisible laser beam for example in the infrared spectrum. The laser source may emit a continuous laser beam (cw laser) or a pulsed laser beam with pulse lengths being for example adapted for the distance measurement purposes. The light detector may be configured for detecting portions of the emitted laser beam upon being reflected at a distant object and to provide signals to the processing unit for analyzing such laser beam portions. The processing unit may then determine for example the time-of-flight in order to finally calculate the distance of the reflecting object.

The laser distance measuring device is applied for measuring a distance between a first position at the displaceable elevator car and a second position being stationary within the elevator shaft. The first position is referred to herein as car reference position and may coincide with any location or installation provided at a fixed position at the elevator car such that the car reference position unambiguously correlates with a position of the car within the elevator shaft. The second position is referred to herein as shaft reference position and is a stationary position fixedly provided within the elevator shaft, for example at a top or at a bottom of the elevator shaft. For example, the laser distance measuring device may be installed at the shaft reference position and a laser beam reflector may be installed at the car reference position, or vice versa. Accordingly, by measuring the distance between the laser distance measuring device and the laser beam reflector, an unambiguous information about the elevator car within the elevator shaft may be acquired.

However, it has been found that determining the location of the car exclusively based on the described measurements provided by the laser distance measuring device may be subject to various influences and disturbances. For example, over time and/or due to mechanical forces acting onto components, the laser distance measuring device and/or the laser beam reflector may be displaced from their original car and shaft reference positions and/or installation orientations, resulting in the measured distance no more precisely representing the current car position in the elevator shaft. Furthermore, depositions of dust or dirt on the laser distance measuring device and/or the laser beam reflector may deteriorate laser beam detections. In worst cases, a direct view between the laser distance measuring device and the laser beam reflector may be obstructed for example by foreign objects within the elevator shaft such that, instead of a distance to the laser beam reflector, a distance to such obstructing foreign object is erroneously measured. Similarly, a position and/or an installation orientation of the laser distance measuring device and/or of the laser beam reflector may be changed excessively such that the laser distance measuring device does no more detect laser beam portions reflected by the laser beam reflector but may detect laser light reflected at other objects and therefore measures a distance to such object instead of the distance to the laser beam reflector.

Generally, in conventional approaches, it was not possible to reliably detect whether or not the distance measurement results provided by the laser distance measuring device are reliable or not. Particularly, as long as the laser distance measuring device provided any signals, it was not possible to determine whether these signals result from detecting laser beam portions reflected at the laser beam reflector upon both, the laser distance measuring device and the laser beam reflector being correctly positioned or whether such signals result from a disturbed or erroneous measurement.

In order to overcome such deficiency, it is proposed to acquire further information which allows improving a reliability of distance measurement results. Particularly, a plausibility of the measured distance as provided by the laser distance measuring device may be evaluated based on further information relating to a laser quality. As described in more detail further below, various types of laser quality data may be acquired and/or such laser quality data may be used in various manners upon evaluating the distance measurement results in order to obtain the required information about the current location of the car in the shaft.

Therein, it is important that the laser quality data relate to a quality of the portions of the laser beam which are detected by the laser distance measuring device such that, based on the detected laser beam portions, the distance between the car reference position and the shaft reference position may be measured. However, the laser quality data themselves do generally not comprise sufficient information such that the indicated distance could be determined based on the laser quality data only. Instead, additional to the laser quality data, further physical characteristics and corresponding data may be acquired upon detecting the reflected laser beam portions in order to enable precise and sufficiently unambiguous distance measurement results. For example, acquired laser beam portions may be analyzed for their oscillation phase and/or their time-of-flight with regards to laser beam portions as originally emitted by a laser source of the laser distance measuring device. While the information comprised in such oscillation phase and/or time-of-flight may be used for precisely calculating a distance to an object at which the laser beam portions are reflected, the laser quality data additionally acquired during such measurement may generally vary in dependence of such distance to the object but such variations are typically not unambiguously dependent from the distance and therefore may not be used for calculating such distance. In other words, while the distance to the object may influence the laser quality data, there may be further effects which may influence the laser quality data in a same or similar manner, such that it may not be determined based on the laser quality data alone whether the distance to the object has changed or whether a variation in the laser quality data is a result of other effects. However, the additionally acquired laser quality data may help in evaluating e.g. the above-mentioned oscillation phase and/or time-of-flight data by for example analyzing the plausibility.

Accordingly, by taking into account not only the distance measured by the laser distance measuring device but additionally taking into account the laser quality data, the information about the current location of the car may be evaluated with a significantly higher reliability. This may be particularly true as disturbances or errors in the distance measurement procedure may be recognized upon comparison with the information comprised in the laser quality data.

For example, in cases where an analysis of the laser quality data indicates that the measured distance appears to be plausible and therefore reliable, the information about the current location of the car may be marked as being reliable. In other words, the information about the current location of the car may not only comprise the actual location data indicating the position of the car in the elevator shaft as measured by the laser distance measuring device but may additionally comprise reliability data indicating a reliability of such location data. For example, the reliability data may indicate that the distance measured by the laser distance measuring device is plausible within tight tolerances, is plausible within acceptable tolerances, is not plausible within acceptable tolerances but is only slightly outside a tolerance range or is not plausible at all. Accordingly, for example other components of the elevator such as an elevator controller subsequently using these location data of the car location information may decide whether these data fulfil reliability requirements based on the additionally provided reliability data.

According to an embodiment, the laser quality data may represent an intensity of the laser beam detected by the laser distance measuring device upon measuring the distance between the car reference position and the shaft reference position.

In other words, the laser quality data may correlate with physical characteristics detected using the sensors comprised in the laser distance measuring device and detected simultaneously with measuring the indicated distance. These physical characteristics shall then correlate with the intensity of the laser beam portions which are detected in the laser distance measuring device and based on which the indicated distance may be determined precisely and sufficiently unambiguously. Such intensity correlates with an illumination power of the laser beam portions incident for example on a surface of a light sensor of the laser distance measuring device.

Generally, the intensity of the laser beam detected by the laser distance measuring device upon measuring the above indicated distance substantially varies in dependence of the distance to be measured. Therein, the larger the distance between the car reference position and the shaft reference position is, the smaller is typically the intensity of the detected laser beam. Generally, the intensity of the detected laser beam may vary linearly or nonlinearly with the indicated distance. Accordingly, by taking into account the measured intensity of the laser beam detected by the laser distance measuring device, the distance determined based on other physical characteristics of such detected laser beam such as its oscillation phase and/or its time-of-flight data may be checked for its plausibility.

For example, if the measured distance appears to currently shrink, i.e. if the car appears to approach the shaft reference position, but the simultaneously acquired laser quality data indicate that the intensity of the laser beam decreases at the same time, instead of increasing as expected in such situations, this may be taken as indicating that there is a certain contradiction between the actual distance measurement of the laser distance measuring device and the behavior of its laser quality data. Accordingly, a plausibility of the distance measurement results provided by the laser distance measuring device may be assumed to be non-optimal or even reduced to an inacceptable degree.

However, additionally to the mentioned dependence on the distance between the shaft reference position and the car reference position, the intensity of the laser beam detected by the laser distance measuring device may depend on further effects and influences.

For example, such intensity may be substantially influenced by any misalignments for example between a laser source of the laser distance measuring device emitting the laser beam and a laser beam reflector reflecting portions of this laser beam. For example, in case of such misalignments, the emitted laser beam may no more be focused onto the laser beam reflector and/or portions of the laser beam reflected at the laser beam reflector may no more be directed towards a light detector comprised in the laser distance measuring device. Accordingly, as a result of such misalignments, the intensity of the detected laser beam may be substantially smaller than in cases of sufficient alignment. Accordingly, detecting a reduced intensity of the laser beam may be taken as indicating the described misalignment and may therefore indicate that the information about the current location of the car as derived from the distance measurement may suffer from reduced reliability.

According to an embodiment, when the laser quality data indicate that the quality of the detected laser beam is below a predefined lower limit, the information about the current location of the car is attributed to be of insufficient reliability.

In other words, the quality of the detected laser beam portions used by the laser distance measuring device may be monitored continuously or repeatedly and acquired laser quality data may be analyzed. In such analysis, it may be checked whether the monitored quality of the detected laser beam portions is below a predefined limit. Such limit may be set prior to starting an operation of the elevator or of its laser distance measuring device. The limit may be set based e.g. on preceding experiments, research, simulations, calculations, etc. Particularly, the limit may be set such that any laser quality data indicating that the quality of the detected laser is below such limit may be taken as indication that some malfunctions, damages, misalignments or other deficiencies occurred upon determining the current location of the car in the shaft using the laser distance measuring device.

Accordingly, upon acquiring laser quality data indicating that the laser quality fell below the predefined lower limit, it may be assumed that the distance measurement results provided by the laser distance measuring device currently suffer from insufficient reliability. Accordingly, such distance measurement results may be marked or discarded accordingly. For example, upon detecting that the acquired laser quality data indicate a laser quality below the predefined limit, data indicating information about insufficient reliability may be issued by the laser distance measuring device together with data representing the distance measurement results. Thus, for example an elevator controller normally using these distance measurement results may take into account such information about insufficient reliability.

For example, when the laser quality data represent an intensity of the laser beam detected by the laser distance measuring device, laser quality data indicating that such intensity falls below a predefined lower intensity limit may be interpreted as indicating insufficient reliability of the distance measurement results acquired simultaneously with the laser distance measuring device.

In such scenario, the lower intensity limit may be set such that even in situations when the elevator car is at a maximum distance from the shaft reference position, i.e. when there is a maximum distance between the laser distance measuring device and a laser beam reflector, the laser beam intensity detected by the light sensor of the laser distance measuring device is above such lower intensity limit as long as the laser distance measuring device and the laser beam reflector are correctly aligned with each other. Accordingly, when the laser beam intensity is detected to be fallen below such predefined limit, this may indicate that there is for example substantial misalignment between the laser distance measuring device and the laser beam reflector.

Alternatively, when the laser beam intensity is detected to be fallen below the predefined limit, this may indicate that there is for example an excessive amount of dirt or dust on components comprised in the laser distance measuring device and/or in the laser beam reflector. Depositions of dirt or dust may substantially reduce an intensity of the emitted laser beam and/or an intensity of reflected portions of such laser beam. Accordingly, the intensity of laser beam portions finally reaching the light detector in the laser distance measuring device may be so low that distance measurements may suffer from insufficient reliability.

According to an embodiment, when the laser quality data indicate that the quality of the detected laser beam suddenly decreases by more than a predefined difference limit, the information about the current location of the car is attributed to be of insufficient reliability.

In other words, when it is detected that the quality of the laser beam portions received at the light sensor of the laser distance measuring device suddenly drops substantially, i.e. drops by more than an acceptable amount, this may be a result of some malfunctions, damages, misalignments or other deficiencies having occurred upon determining the current location of the car in the shaft using the laser distance measuring device. Accordingly, laser quality data indicating such sudden drop may be taken as indicator for such malfunctions, damages, misalignments, etc. and the corresponding laser distance measurements provided by the laser distance measuring device may be marked or discarded accordingly.

For example, a sudden decrease in laser beam intensity for the detected laser beam portions may be a result of a suddenly effected misalignment between the laser beam source in the laser distance measuring device and the laser beam reflector. Such misalignment may result in the emitted laser beam no more being reflected by the laser beam reflector but by other surfaces within the elevator arrangement. Alternatively, such misalignment may result in the emitted laser beam being reflected by the laser beam reflector in other directions instead of being reflected towards the light sensor in the laser distance measuring device. Such sudden misalignments may occur for example during maintenance work, when i.e. a technician hits the laser beam reflector and unintendedly deforms it changing its orientation.

Similarly as described above for the preceding embodiment, for example an elevator controller normally using distance measurement results may take into account markers serving as information about insufficient reliability.

According to an embodiment, there are situations during an operation of the elevator in which the laser distance measuring device is temporarily deactivated. In such circumstances, upon executing the method described herein, the distance shall be measured and the laser quality data is acquired after reactivating the laser distance measuring device after such preceding temporary deactivation.

It has been found that it may be advantageous to temporarily actively deactivate the laser distance measuring device under certain conditions. Thereby, for example an energy consumption caused by the laser distance measuring device may be reduced. Furthermore, it has been observed that the laser distance measuring device may be subject to unintended temporary deactivation for example in cases of a power supply interruption, blackout or similar events. As a further alternative, the entire elevator arrangement may be temporarily stopped or shut down for example due to a detection of a safety critical malfunction or in order to perform maintenance works. The deactivation of the laser distance measuring device may last for some second (e.g. more than 10 s), some minutes (e.g. more than 10 min), some hours (e.g. more than 1 h) or even some days (e.g. more than 1 day).

It has been found that particularly during periods of such deactivation, the elevator arrangement and particularly its laser distance measuring device may be prone to changes and modifications which may result in a determination of the current car location information being erroneous or at least no more sufficiently reliable. For example, during a temporary deactivation, components of the laser distance measuring device or the laser beam reflector may be slightly displaced in their positions relative to the intended car reference position and shaft reference position, respectively. As another example, such components may be damaged or the laser beam reflector may even be unintendedly destroyed e.g. during maintenance works.

While such changes and modifications in the laser distance measuring device might be detectable during normal operation of the device, for example due to sudden changes in signals provided by such device, the changes and modifications may remain undetected during periods of temporary deactivation of the device. Accordingly, it is suggested to specifically measure the distance between the car reference position and the shaft reference position using the laser distance measuring device as soon as possible after the laser distance measuring device is reactivated and to then timely also acquire laser quality data in order to allow for example an evaluation or an analysis of a plausibility of such measured distance. For example, such distance measuring, laser quality data acquisition and/or plausibility analyzing procedure may be performed when or shortly before normal operation of the elevator and its laser distance measuring device is resumed. As an example, such procedure may be performed within less than one minute, preferably less than ten seconds, after reactivating the laser distance measuring device.

In a further specified embodiment, the laser distance measuring device is temporarily deactivated when the car is stopped within the shaft and the laser distance measuring device is reactivated when the car is started to be displaced within the shaft.

For example, the laser distance measuring device may be deactivated as long as the car is stopped at one of the floors. In such situation, the car is generally not allowed to significantly move within the shaft and, accordingly, the current location of the car may be assumed to be stationary such that there may be no need to repeatedly measure this current location and associated energy consumption may be saved. When the car is started to be displaced again within the shaft, the laser distance measuring device may be reactivated such that the current location of the travelling car may be measured continuously or repeatedly. Upon such reactivation, the distance indicating the current car location is measured and is evaluated using the laser quality data and possibly its plausibility is analyzed. This may be done coincidentally with starting the displacement of the car or, preferably, shortly before starting such displacement. Under certain circumstances such as fulfilling predefined safety requirements, such distance measurement, evaluation and/or plausibility analysis may also be performed shortly after starting the displacement, for example within a sufficiently short duration before a car velocity exceeds an acceptable predetermined limit.

It is to be noted that the applicant of the present application filed another patent application concurrently, i.e. at the same day, with the present application. This other patent application has the title “Method and controller for determining information about a current location of a cabin car in a shaft of an elevator”. The determination method described therein comprises measuring a distance between a car reference position at the car and a shaft reference position in the shaft using a laser distance measuring device, analyzing a plausibility of the measured distance taking into account plausibility information correlating with the current location of the car independently from the distance measuring, and, finally, determining the information about the current location of the car based on the measured distance and the analyzed plausibility. Embodiments and details of the determination method described in the other patent application may be applicable or adapted to the method for evaluating the information about the current car location described herein. Accordingly, the entire content of the other patent application (WO 2022/129208 A1) shall be included herein by reference.

In the embodiments of the method for operating an elevator in accordance with the second aspect of the present invention, various functions of the elevator may be controlled based on the information about the current location of the car in the elevator shaft as evaluated with the method proposed herein. For example, the displacement of the elevator car within the elevator shaft and/or the stopping of the elevator car at intended locations such as at landings may be controlled based on the information about the current car location. Accordingly, this information may e.g. be provided to and used by an elevator controller controlling a functionality of an elevator drive engine.

Embodiments of the controller according to the third aspect of the present invention may for example comprise one or more interfaces via which the controller may receive signals or data provided by the laser distance measuring device. Furthermore, the controller may comprise one or more interfaces via which it may receive signals or data from other devices such as for example from door sensors, acceleration sensors, encoder sensors, brake sensors, etc. Accordingly, the signals received via such interfaces may be used for acquiring the laser quality data and/or other data being useful for evaluating and/or determining the information about the current location of the elevator car. Furthermore, the controller may comprise a processing unit for processing both, the signals or data from the laser distance measuring device as well as the signals or data received from other devices for deriving laser quality data, in order to then for example analyze the plausibility of the measured distance and determine the information about the current location of the car based on the measured distance and the analyzed plausibility. Furthermore, the controller may comprise additional components such as a memory for storing for example distance information and/or laser quality data as described above.

Embodiments of the elevator according to the fourth aspect of the present invention comprise an elevator car being displaceable throughout an elevator shaft. Furthermore, the elevator comprises a laser distance measuring device and a controller as described herein. The laser distance measuring device may be attached to the elevator car and a laser beam reflector may be fixedly installed within the elevator shaft, or vice versa. The controller may control one or more functionalities of the elevator and may for example communicate with other components of the elevator such as its drive engine.

It shall be noted that possible features and advantages of embodiments of the invention are described herein partly with respect to a method for evaluating and/or determining current car location information, partly with respect to a method for operating an elevator using such information, partly with respect to a controller configured for implementing such method and partly with respect to an elevator comprising such controller. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawing. However, neither the drawing nor the description shall be interpreted as limiting the invention.

### DESCRIPTION OF THE DRAWINGS

FIG. 1 shows an elevator with a controller for implementing a method for evaluating information about a current location of a car in a shaft in accordance with an embodiment of the present invention.

The FIGURE is only schematic and not to scale. Same reference signs refer to same or similar features.

### DETAILED DESCRIPTION

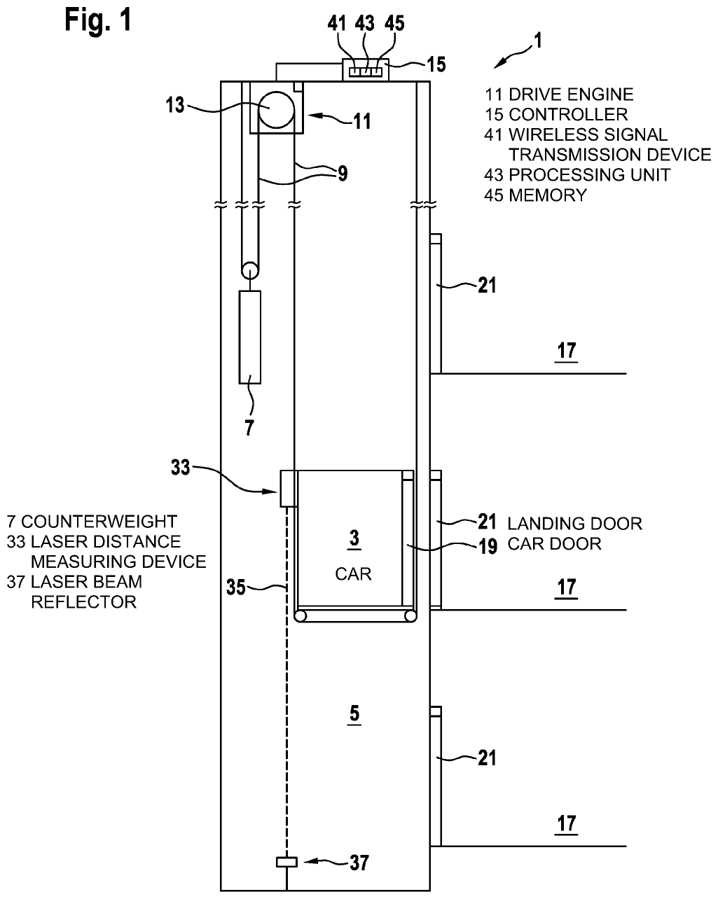

FIG. 1 shows an elevator 1 in which a car 3 may be displaced vertically along a shaft 5. The car 3 and a counterweight 7 are suspended by a suspension traction means 9. The suspension traction means 9 extends along a circumferential surface of a drive disk 13 of a drive engine 11. An operation of the drive engine 11 is controlled by a controller 15. For example, the controller 15 may control the drive engine 11 such that the car 3 may be stopped at one of several landings 17 such that a car door 19 provided at the car 3 is arranged at a position opposite to a landing door 21 provided at the landing 17.

In the elevator 1 described herein, a laser distance measuring device 33 is provided. The laser distance measuring device 33 shall be used in evaluating and determining information about a current location of the car 3 in the shaft 5.

In the example shown in the FIGURE, the laser distance measuring device 33 is fixed to a side of the car 3 and emits a laser beam 35 in a downward direction. The laser beam 35 is directed towards a laser beam reflector 37 installed at or close to a bottom of the shaft 5.

In order to determine information about the current location of the car 3 in the shaft 5, a distance between a car reference position at the car 3 and a shaft reference position at the shaft 5 is measured using the laser distance measuring device 33. Furthermore, laser quality data is acquired from the laser distance measuring device 33, this laser quality data representing a quality of portions of the laser beam 35 upon being reflected at the laser beam reflector 37 and then being detected by a light detector comprised in the laser distance measuring device 33 upon measuring the above indicated distance. Taking into account both the measured distance and the laser quality data, the information about the current location of the car 3 within the shaft 5 may be evaluated.

In such procedure, the laser quality data may represent an intensity of the laser beam 35 upon being detected by the laser distance measuring device 33. Alternatively, the laser quality data may relate to other physical characteristics of the laser beam 35 upon being reflected at an object such as the laser beam reflector 37 and then being detected in the laser distance measuring device 33. Such physical characteristics may relate for example to a laser beam width, a length of laser beam pulses, a spectrum of the laser beam, etc. More generally, such physical characteristics may relate to characteristics of the laser beam 35 which may be influenced upon any malfunctions, disturbances, deteriorations, misalignments and/or other deficiencies that occur during elevator operation, such malfunctions, disturbances, deteriorations, misalignments and/or other deficiencies resulting in distance measurements tending to be insufficiently reliable.

Specifically, laser quality data which may represent a quality of the laser beam 35 upon being detected in the laser distance measuring device 33 after being reflected at the laser beam reflector 37. For example, a detected light intensity may vary depending on the current location of the car 3 and is, correspondingly, depending on the distance the laser beam 35 has to travel from the laser distance measuring device 33 to the laser beam reflector 37 and back. Furthermore, the detected laser light intensity will in most cases strongly reduce when for example the laser beam 35 is misaligned and is no more focused onto the laser beam reflector 37 or, upon being reflected at the laser beam reflector 37, no more reaches the light detector in the laser distance measuring device 33. Such light intensity reduction may therefore indicate a loss in plausibility or reliability of measurements provided by the laser distance measuring device 33.

For example, the information about the current location of the car as obtained based on the distance measurement results provided by the laser distance measuring device 33 may be supplemented by specific markers. Such markers may indicate a reliability of such car location information. Specifically, the car location information may be attributed to be of insufficient reliability for example in cases when the laser quality data indicates that the quality of the detected laser beam 35 is below a predefined lower limit and/or the laser quality data indicate that the quality of the detected laser beam 35 suddenly decreases by more than a predefined difference limit.

Particularly, the presented procedure may be executed after the laser distance measuring device 33 has been temporarily deactivated for example during a stop of the car 3 at one of the landings 17. Accordingly, upon resuming the operation of the laser distance measuring device 33 upon reactivation, the distance between the laser distance measuring device 33 and the laser beam reflector 37 may be measured and the measuring results may be checked for example for their plausibility in order to thereby significantly increase a reliability of the information about the current location of the car 3 provided thereby. Accordingly, such information may be used e.g. for safety critical functionalities such as controlling an operation of the drive engine 11 for displacing the car 3 throughout the shaft 5.

Generally, signals or data may be transmitted between the various sensors and information sources, on the one side, and the controller 15, on the other side, for example using a wireless signal transmission device 41. Alternatively, hardwiring may be established. Particularly, the laser distance measuring device 33 may output various signals or data including for example information about an oscillation phase, a time-of-flight and/or a quality of a detected laser beam 35. These signals and data may be transmitted from the laser distance measuring device 33 to the controller 15. The signals or data may then be processed in a processing unit 43. Furthermore, the signals or data may be stored in memory 45 before or after the processing thereof.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. A method for evaluating information about a current location of a car in a shaft of an elevator, the method comprising the steps of:
measuring a distance between a car reference position at the car and a shaft reference position in the shaft using a laser distance measuring device;
acquiring laser quality data from the laser distance measuring device, the laser quality data representing a quality of a laser beam detected by the laser distance measuring device upon measuring the distance; and
evaluating the information about the current location of the car taking into account the measured distance and the laser quality data.

11. The method according to claim 10 wherein the laser quality data represent an intensity of the laser beam detected by the laser distance measuring device upon measuring the distance.

12. The method according to claim 10 wherein, when the laser quality data indicate that the quality of the detected laser beam is below a predefined lower limit, attributing the information about the current location of the car to be of insufficient reliability to use for controlling the elevator.

13. The method according to claim 10 wherein, when the laser quality data indicate that the quality of the detected laser beam suddenly decreases by more than a predefined difference limit, attributing the information about the current location of the car to be of insufficient reliability to use for controlling the elevator.

14. The method according to claim 10 including temporarily deactivating the laser distance measuring device, and measuring the distance and acquiring the laser quality data after reactivating the laser distance measuring device.

15. The method according to claim 14 wherein the laser distance measuring device is temporarily deactivated when the car is stopped within the shaft, and the laser distance measuring device is reactivated when the car is started to be displaced within the shaft.

16. A method for operating an elevator comprising controlling functions of the elevator based on information about a current location of a car in a shaft of the elevator and evaluating the information using the method according to claim 10.

17. A controller for determining information about a current location of a car in a shaft of an elevator, wherein the controller is configured to at least one of implement and control the elevator using the method according to claim 10.

18. An elevator comprising:
a car;
a shaft;
a laser distance measuring device adapted to measure a distance between a car reference position at the car and a shaft reference position in the shaft; and
a controller according to claim 17 controlling the elevator.
